(19) United States
(12) Patent Application Publication
(10) Pub. No.: US 2003/0036580 A1
(43) Pub. Date: Feb. 20, 2003

(54) Bromine-containing radiation curable acrylates and methacrylates

(76) Inventors: Mingxin Fan, West Chester, PA (US); Gary Ceska, Exton, PA (US); James Horgan, West Chester, PA (US)

Correspondence Address: COZEN AND O'CONNOR, 1900 MARKET STREET, PHILADELPHIA, PA, 19103, US

(21) Appl. No.: 09/932,486

(22) Filed: Aug. 17, 2001

(51) Int. Cl. C08G 18/62

(52) U.S. Cl. 522/90

(57) ABSTRACT

Bromine-containing urethane (meth)acrylate oligomers which are useful in the field of radiation curable coatings wherein flame redardancy, compatibility with acrylic monomers and other oligomers, and high refractive indices are desired. Coatings and adhesives prepared from the oligomers have good refractive indices. The oligomers are obtained by reacting (A) one or more polyisocyanates, (B) one or more hydroxy functional (meth)acrylates, and (C) one or more bromine-containing alcohols.

### BACKGROUND OF THE INVENTION

This invention relates to the field of imparting flame retardancy to coatings, adhesives, and light carrying acrylic materials.

Ultraviolet light and electron beam (UV/EB) curing methods for coatings, adhesives, and light carrying acrylic materials are becoming more and more popular due to their low or zero volatile organic compound levels (VOC) and high productivity. Acrylic monomers and oligomers have been developed especially for UV/EB curable systems.

To impart fire and flame retardance to structural materials for airplanes and motor vehicle construction, electrical and electronic applications, coatings, and adhesives, bromine and phosphorus-containing additives have been used. However, in the special case of acrylic optical communication materials such as fiber, materials with high refractive indices are required, but previously available flame retardant additives reduce the refractive indices. Prior to the present invention, there has not been a commercially acceptable flame retardant system for acrylic materials for applications where high refractive indices are required.

The previously available additives which can be used to enhance the fire and flame retardance of UV and EB curable acrylic resins are non-reactive and can not be incorporated into a crosslinked network. Examples of such non-reactive flame retardant materials include brominated dialkyl phthalate, dioctyl tetrabromophthalate, brominated styrene polymers, and brominated Bisphenol A compounds. These non-reactive bromine-containing materials are typically high melting solids and are not compatible with monomers and oligomers in radiation cure systems, resulting in opaque final properties. For these reasons, clear, radiation curable, flame retardant acrylic compositions useful for optical applications are very difficult to obtain.

It is therefore an objective of this invention is to provide flame retardant acrylic compositions, methods of making them, and improved coating and adhesive compositions.

Another objective of this invention is to provide flame retardant materials with high refractive indices for optical applications such as optical lenses, optical devices, and optical/electrical hybrid devices, the improved lenses and optical and optical/electrical devices, and related methods of preparation and use.

### SUMMARY OF THE INVENTION

These objects, and other objects as will become apparant from the following disclosure, are achieved by the present invention which comrises in one aspect flame retardancy-imparting, polymerizable (meth)acrylate oligomers which are completely compatible with UV/EB curable monomers and oligomers and are especially useful in applications where high refractive indices are desired. The term “(meth)acrylate” is used herein as an abbreviation to mean both acrylates and methacrylates. These new materials contain bromine which enhances the fire/flame retardant properties and increases the refractive indices.

The oligomers of the invention are prepared by reacting (A) one or more diisocyanates, (B) one or more hydroxyl-containing (meth)acrylates, and (C) one or more bromine-containing alcohols.

In another aspect, the invention comprises coating and adhesive compositions prepared by radiation curing the aforementioned oligomer.

The invention also comprises the process of preparing such bromine-containing oligomers, a process of curing the bromine-containing oligomers, and articles having high refractive index which are coated with the radiation cured bromine-containing oligomers, or contain a radiation cured adhesive based on the bromine-containing oligomers.

### DETAILED DESCRIPTION OF THE INVENTION AND THE PREFERRED EMBODIMENTS

As mentioned above, the oligomers are prepared according to the invention by reacting (A) one or more diisocyanates, (B) one or more hydroxyl-containing (meth)acrylates, and (C) one or more bromine-containing alcohols.

Suitable hydroxyl containing (meth)acrylates (B) include, for example, hydroxyethyl acrylate, hydroxyethyl methacrylate, hydroxypropyl acrylate, hydroxypropyl methacrylate, hydroxybutyl acrylate, hydroxybutyl methacrylate, polyester modified hydroxyalkyl (meth)acrylates, hydroxypoly(propylene oxide) (meth)acrylates, hydroxypoly(ethylene oxide) (meth)acrylates, pentaerythritol triacrylate, trimethyolpropane diacrylate, glycerol diacrylate, glycerol dimethacrylate, and alkoxylated hydroxyl containing methacrylates. The alkoxylation can be provided, for example, by ethoxylation, propoxylation, or combined ethoxylation and propoxylation.

Suitable bromine-containing alcohols (C) can be aromatic or aliphatic in nature, and can contain one or more bromines, i.e., monobromine or multi-bromine. A few examples of such bromine-containing alcohols are tribromoneopentyl alcohol, dibromoneopentyl glycol, tribromoethanol, tetrabromobisphenol A ethoxylate, and tetrabromobisphenol A propoxylate.

The bromine-containing alcohols (C) can be transformed into urethane (meth)acrylates using hydroxyl-containing (meth)acrylates (B) and diisocyanates (A).

Suitable diisocyanates (A) are toluene diisocyanate, isophorone diisocyanate, hexamethylene diisocyanate, trimethylhexamethylene diisocyanate, phenyl isocyanate, 4,4′-diphenylmethane diisocyanate, 4,4′-dicyclohexylmethane diisocyanate, and butylene diisocyanate, among others.

It is desirable to use about 0.5 and 2.0, preferably about 0.75 and 1.5, more preferably about 0.9 and 1.1 equivalents of isocyanate for each equivalent of hydroxyl. In this manner, it is assured that there are few free alcohols or free isocyanates remaining in the final oligomers.

The diisocyanate (A) can be reacted with the bromine-containing alcohol (C) first, followed by end capping with a hydroxyl-containing (meth)acrylate. Alternatively, the oligomers can be prepared by reacting diisocyanate (A) with a hydroxyl-containing (meth)acrylate (B) followed by bromine-containing alcohol (C).

The final, condensed product will contain (meth)acrylate functionalities and can be reacted or crosslinked with free radical mechanism, either with free radical initiators such as peroxides or, more typically, by known radiation curing processes such as UV and EB.

The bromine-containing oligomers are compatible with typical UV/EB curable monomers and oligomers, possibly due to the less symmetric nature of their molecular structure. Additional flame retardancy can be imparted to the cured coatings and adhesives by use of phosphorus containing materials, although this is usually not necessary. The bromine-containing oligomers can be cured as high refractive index coatings for optical lenses and as optical coatings for optical communication devices.

The following non-limiting examples illustrate a few embodiments.

### EXAMPLES

### Example 1

### Preparation of Aliphatic Urethane Acrylate Bromine-Containing Oligomers

0.25 g of 4-methoxyphenol, 1.5 g of dibutyltin dilaurate, 555.0 g of isophorone diisocyanate were charged into a reactor. 290.0 g of hydroxyethyl acrylate was added slowly while the mixture was stirred, followed by introduction of 333.0 g of dibromoneopentyl glycol. The mixture was heated to 100° C. when an exotherm was noticed which resulted in the temperature increase to 109° C. The reaction mixture was kept at 90-100° C. for three hours and a very viscous resin was obtained. The material has a refractive index value of 1.53.

### Example 2

### Preparation of Aromatic Urethane Acrylate Bromine-Containing Oligomers

To a reactor were charged 0.8 g of dibutyltin dilaurate, 0.4 g of 4-methoxyphenol, 130 g of SR348 (bisphenol A ethoxylate dimethacrylate), and 266.5 g of tetrabromo bisphenol A ethoxylate. The mixture was stirred and 166.5 g of isophorone diisocyanate was added slowly followed by addition of 87.0 g of hydroxyethyl acrylate. The reaction mixture was then kept at 90-100° C. for five hours when the reaction was completed. A very viscous resin was obtained with a viscosity of 194,000 cps at 60° C. and a refractive index of 1.55 at 25° C.

### Example 3

### Compatibility With Radiation Curable Acrylate Monomers

The resin prepared in Examples 1 and 2 were tested for compatibility with commonly used radiation curable (meth)acrylates. In the following table, the numbers are the weight in grams, E1 is the resin from Example 1, E2 is the resin from Example 2, TPGDA is tripropyl glycol diacrylate, HDDA is hexanediol diacrylate, TMPTA is trimethylolpropane triacrylate, and EOTMPTA is ethoxylated trimethylolpropane triacrylate.

C means that the final mixture is clear and compatible. The tests indicate that the resins of this invention are completely compatible.

TABLE 1
COMBATIBILITY TEST

| | A | B | C | D | E | F | G | H |
|---|---|---|---|---|---|---|---|---|
| E1 | 5 | 5 | 5 | 5 | | | | |
| E2 | | | | | 5 | 5 | 5 | 5 |
| TPGDA | 5 | | | | 5 | | | |
| HDDA | | 5 | | | | 5 | | |
| TMPTA | | | 5 | | | | 5 | |
| EOTMPTA | | | | 5 | | | | 5 |
| Final Mixture | C | C | C | C | C | C | C | C |

### Example 4

### UV Cure of the Bromine-Containing Oligomers

The resins prepared in Example 1 and 2 were UV radiation cured by blending with 5% photoinitiator (KIP 100F, available from Sartomer Company, Inc.) and applying to aluminium panels using a #10 application wire rod, followed by curing the coated substrates on a UV curing unit equipped with a 300 watts/inch Hg lamp at a speed of 50 feet per minute (fpm).

The blends were completely cured and hard coatings were obtained. The Tg of the final cured coatings were 79° C. and 87° C. respectively.

While the invention has been described in sufficient detail for those skilled in this art to make and use it, various modifications, alternatives, and improvements should become readily apparant without departing from the spirit and scope of the invention.

What is claimed is:

1. A polyerizable (meth)acrylate oligomer obtained by reacting (A) one or more diisocyanates; (B) one or more hydroxy functional (meth)acrylates, and (C) one or more bromine-containing alcohols.

2. Oligomer of claim 1 wherein the bromine-containing alcohol (C) is selected from the group consisting of tribromo neopentyl alcohol, dibromo neopentyl glycol, tribromo ethanol, tetrabromo bisphenol A ethoxylate, and tetrabromo bisphenol A propoxylate.

3. Oligomer of claim 1 wherein the hydroxy functional (meth)acrylates (B) are selected from the group consisting of hydroxyethyl (meth)acrylate, hydroxypropyl (meth)acrylate, hydroxybutyl (meth)acrylate, trimethylolpropane mono- and di-(meth)acrylate, pentaerythritol mono-, di-, tri- (meth)acrylate, dipentaerythritol mono-, di-,tri-, tetra-, and penta-(meth)acrylate, neopentyl glycol (meth)acrylate, hexanediol mono(meth)acrylate, tris(2-hydroxyethyl)isocyanurate mono- and di(meth)acrylate, polypropylene glycol mono(meth)acrylate, polyethylene glycol mono (meth)acrylate, polypropylene/polyethylene glycol mono(meth)acrylate, polybutyl glycol mono(meth)acrylate, polytetramethylene glycol mono(meth)acrylate, hydroxy polycaprolactone mono(meth)acrylate, optionally comprising ether groups obtained by ethxylation and/or propoxylation.

4. Oligomer of claim 3 whrein the hydroxy functional (meth)acrylate (B) is alkoxylated with ethylene oxide, propylene oxide, or a mixture of ethylene oxide and propylene oxide.

5. Oligomer of claim 1 wherein the diiscocyanate (A) is selected from the group consisting of hexamethylene diisocyanate, isophorone diisocyanate, cyclohexane-1,4-diisocyanate, methylene bis(4-cyclohexylisocyanate), toluene diisocyanate, diphenylmethane 4,4-diisocyanate, xylene diisocyanate, 1,4-phenylene diisocyanate, 4,4′-dicyclohexylmethane diisocyanate, butylene diisocyanate, and trimethyl hexamethylene diisocyanate.

6. Oligomer of claim 1 wherein the molar ratio of (A) to (B) is 1.01 to 1.5.

7. Oligomer of claim 1 wherein (A), (B) and (C) are mixed together and reacted.

8. Oligomer of claim 1 wherein (A) and (B) are reacted so as to form an isocyanate functional acrylic polymer, followed by reaction of said isocyanate functional acrylic polymer with (C).

9. Coating and adhesive compositions prepared by radiation curing the oligomer of claim 1.

10. Process of preparing a flame retardancy imparting, radiation curable oligomer comprising reacting (A) one or more diisocyanates; (B) one or more hydroxy functional (meth)acrylates, and (C) one or more bromine-containing alcohols.

11. Process of claim 12 wherein a molar excess of (A) is reacted with (B), followed by reacting the resultant isocyanate terminated compound with (C) so as to form a bromine-containing (meth)acryalate functional oligomer.

12. A composition comprising a compatible mixture of one or more oligomers of claim 1 with one or more (meth)acrylic monomers.

13. Composition of claim 12 wherein the one or more (meth)acrylic monomers are selected from the group consisting of tripropyl glycol diacrylate, hexanediol diacrylate, trimethylolpropane triacrylate, and ethoxylated trimethylolpropane triacrylate.

14. A radiation cured coating or adhesive prepared by curing a composition of claim 12 with UV or EB radiation.

15. Composition of claim 12, further including one or more flame retardant additives in addition to the oligomers.

16. Composition of claim 15 wherein the including one or more flame retardant additives in addition to the oligomers are selected from phosphorus containing compounds.

17. An article in the form of an optical fiber, optical lens, and optical communication device which is coated with, or contains adhesive derived from, an oligomer of claim 1.

18. Article of claim 17 wherein the oligomer is UV or EB cured.
